(19) United States
(12) Patent Application Publication
(10) Pub. No.: US 2010/0129639 A1
(43) Pub. Date: May 27, 2010

(54) SURFACE HAVING A NANOPOROUS COATING, METHODS OF MANUFACTURE THEREOF AND ARTICLES COMPRISING THE SAME

(75) Inventors: Tunc Icoz, Schenectady, NY (US); Anthony Yu-Chung Ku, Rexford, NY (US); James Anthony Ruud, Delmar, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: General Electric Company, Schenectady, NY (US)

(21) Appl. No.: 12/277,802

(22) Filed: Nov. 25, 2008

(51) Int. Cl. B32B 5/16; B32B 5/18; B05D 5/00; B05D 1/00; B05D 1/06; B05D 1/18

(52) U.S. Cl. 428/317.9; 428/304.4; 427/245; 427/240; 427/475; 427/458; 977/773

(57) ABSTRACT

Disclosed herein is an that includes a substrate; and a nanoporous coating disposed thereon; the nanoporous coating having a thickness of about 5 nanometers to about 10 micrometers; where an interface between the substrate and the nanoporous coating is disposed at an angle of about 60 degrees to about 120 degrees to a horizontal; the nanoporous coating being in contact with a liquid; the nanoporous coating being operative to improve the critical heat flux by an amount of about 20% to about 100% over a surface that does not have a nanoporous coating.

### BACKGROUND OF THE INVENTION

This disclosure relates to a surface having a nanoporous coating, methods of manufacture thereof and articles comprising the same.

When a fluid contained in a vessel is heated to boiling, bubbles nucleate at the surface and depart from the surface thus removing heat from the source. The bubble size and departure frequency depend on the heat flux and temperature.

With reference to the FIGS. 1 and 2, it can be seen that as heat flux Q increases on the surface from Q₁ to Q₃, the bubbles get larger and nucleation frequency increases. This continues until a critical heat flux point (hereinafter “critical heat flux condition”) Q₄ is achieved. Critical heat flux (CHF) describes the thermal limit of a phenomenon where a phase change occurs during heating (such as bubbles forming on a metal surface used to heat water), which suddenly decreases the efficiency of heat transfer, thus causing localized overheating of the heating surface. This decrease in efficiency of heat transfer can be seen in the FIG. 2, where at the critical heat flux condition, the heat transfer flow from the surface plateaus off Critical heat flux is also defined as the condition at which heat transfer coefficient drops severely due to vapor blanket or due to the ability to lose wetting. When critical heat flux is achieved, a very small increase in heat flux causes a dry-out, which results in very high temperature rise.

At the critical heat flux condition, the bubbles get so large in size and number that they create a vapor film on the surface thereby reducing wetting. This phenomena is called dry-out because the instant the vapor blanket is formed, the surface temperatures increase very rapidly and can exceed the melting temperature of the material of the surface.

The problem of critical heat flux manifests itself in a greater manner on a vertical surface than on a horizontal surface. For example, during the transfer a heated fluid in a horizontal direction, gravity causes the fluid to stay in contact with the horizontal surface, which can delay the onset of critical heat flux. In addition, pumps are frequently used to transfer fluids across heated surfaces, thus minimizing contact with the surface. It is more difficult to control critical heat flux on vertical surfaces. The buoyancy of heated fluids tends to drive the fluid away from a vertical surface thus leading to an early onset of the critical heat flux condition. In addition, gravity does not facilitate the retention of contact between the fluid and the surface as it does in the case of horizontal surfaces.

Delaying the onset of the critical heat flux condition enables the achievement of higher heat fluxes on the surface, which translates to greater power generation and enhanced safety. This delay in the achievement of the critical heat flux is valuable in power generation plants that involve nuclear reactors. It is also very valuable in power electronics. Delaying the onset of the critical heat flux condition is therefore desirable and can have many benefits in energy conversion as well as in thermal management. It is particularly desirable in vertical surfaces where gravity does not play a role in facilitating retention of the fluid with the surface.

### BRIEF DESCRIPTION OF THE INVENTION

Disclosed herein is an article comprising a substrate; and a nanoporous coating disposed thereon; the nanoporous coating having a thickness of about 5 nanometers to about 10 micrometers; where an interface between the substrate and the nanoporous coating is disposed at an angle of about 60 degrees to about 120 degrees to a horizontal; the nanoporous coating being in contact with a liquid; the nanoporous coating being operative to improve the critical heat flux by an amount of about 20% to about 100% over a surface that does not have a nanoporous coating.

Disclosed herein too is an article comprising a substrate; and a nanoporous coating disposed thereon; the nanoporous coating comprising a metal or a metal oxide; the nanoporous coating having a thickness of about 5 nanometers to about 10 micrometers; where an interface between the substrate and the nanoporous coating is disposed at an angle of about 60 degrees to about 120 degrees to a horizontal.

Disclosed herein too is a method comprising disposing a slurry upon a substrate; the slurry comprising a liquid and about 0.0001 to about 1 volume percent of nanoparticles, based upon the total volume of the slurry; and evaporating the liquid from the substrate to form a nanoporous coating having a thickness of about 5 nanometers to about 10 micrometers upon the substrate.

Disclosed herein too is a method comprising disposing a slurry upon a substrate; the slurry comprising a first liquid and about 0.0001 to about 1 volume percent of nanoparticles, based upon the total volume of the slurry; evaporating the first liquid to form a nanoporous coating having a thickness of about 5 nanometers to about 10 micrometers upon the substrate; and contacting the nanoporous coating with a second liquid; where the onset of the critical heat flux condition is increased by an amount of about 20% to about 100% over a surface that does not have the nanoporous coating.

### BRIEF DESCRIPTION OF THE DRAWINGS

FIG. 1 shows that as heat flux Q increases on the surface from Q₁ to Q₃, the bubbles get larger and nucleation frequency increases;

FIG. 2 shows that at the critical heat flux condition, the heat transfer flow from the surface plateaus off;

FIG. 3 depicts the experimental set-up for the Examples;

FIG. 4(a) is a graphical plot of heat flux in watts per square centimeter measured as a function of the difference in temperature (in degrees centigrade) between the nichrome heater surface temperature and the fluid temperature; and

FIG. 4(b) is a graphical plot that depicts the critical heat flux for pure water on a polished nichrome surface, pure water on the nanoporous surface and for water containing alumina nanoparticles on a polished nichrome heating surface. The critical flux is measured against the difference in temperature between the temperature of the nichrome surface and the surface of the surrounding water.

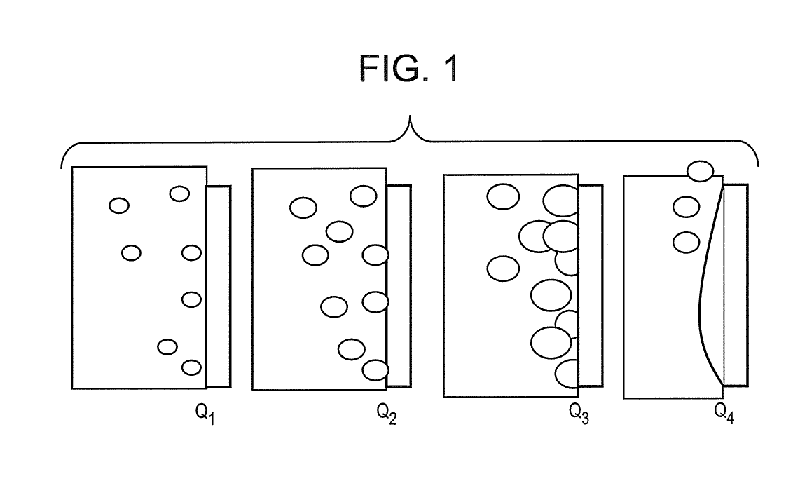

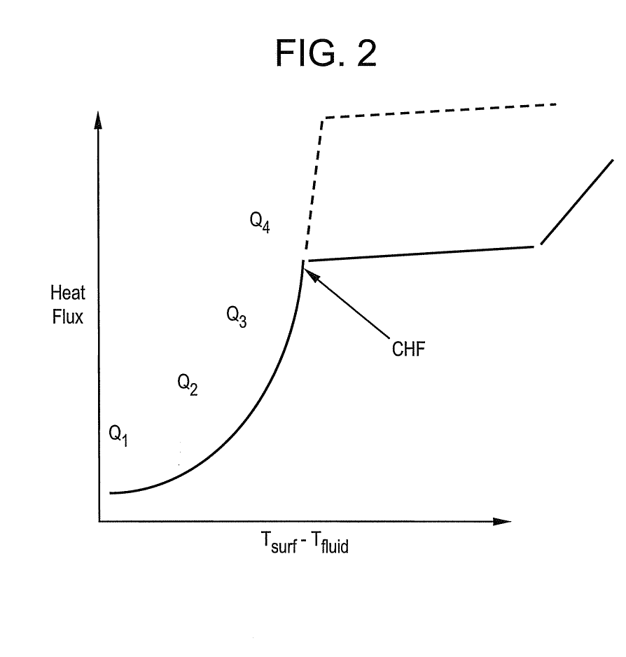

### DETAILED DESCRIPTION OF THE INVENTION

The disclosure will be described more fully hereinafter with reference to the accompanying drawings, in which exemplary embodiments are shown. As one would realize, the described embodiments may be modified in various different ways, all without departing from the spirit or scope of the invention.

In the drawings, the thickness of layers, films, panels, regions, and the like, are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, and the like, may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “upper” or “over” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Disclosed herein is a substrate having a surface that is designed to delay the onset of the critical heat flux condition by an amount of up to about 100% or greater, when the surface is exposed to heating in the presence of water. In one embodiment, an interface between the substrate and the nanoporous coating is disposed at an angle of about 60 degrees to about 120 degrees to a horizontal.

In one embodiment, an interface between the substrate and the nanoporous coating is disposed at an angle of about 75 degrees to about 105 degrees to a horizontal. In another embodiment, an interface between the substrate and the nanoporous coating is disposed at an angle of about 85 degrees to about 95 degrees to a horizontal. In yet another embodiment, an interface between the substrate and the nanoporous coating is disposed at an angle of about 90 degrees to a horizontal.

The nanoporous surface delays the onset of the critical heat flux condition by an amount that is significantly greater than a comparative surface that has a micro-porous coating because of the significantly greater number of open cells per unit thickness of nanoporous coating. Without being limited by theory, the porous structure of the nanoporous coating creates a large number of active bubble nucleation sites. While the open cells inside the porous coating promote bubble departure from the surface due to higher localized temperature and pressure in these cells, the size of the cells essentially reduces the critical bubble diameter necessary for departure from the surface. The result of this restriction on bubble size by the cells is smaller bubbles that depart the nanoporous surface at a higher rate than that for a comparative smooth surface or for a surface having a microporous coating. This delays the vapor blanket formation also known as dry-out, thus delaying the onset of the critical heat flux condition.

The use of nanoporous surface provides numerous advantages over a comparative microporous surface. A microporous surface has pores that are in the micrometer range (i.e., greater than or equal to about 1,000 nanometers). The microporous coating also has a thickness of greater than or equal to about 1 micrometer. The smaller cell size for the nanoporous surface results in lower critical bubble diameter for departure so the bubbles leaving the surface are smaller than that with the microporous surface. In addition, because the nanoporous coating thickness is smaller than the thickness of a coating having a microporous structure, the thermal resistance to conduction is minimized especially for non-metallic coatings (e.g., ceramic or carbonaceous coatings).

The substrate can comprise a metal, a ceramic or a polymer. The substrate can be planar, non-planar, or a combination comprising a planar and a non-planar surface.

The nanoporous coating can comprise a metal, a polymer, a ceramic, or a combination comprising at least one of the foregoing metals, polymers or ceramics. In one embodiment, the nanoporous coating generally comprises nanoparticles that can exist in the form of agglomerates and aggregates, thus providing a coating having a high surface area. An aggregate comprises more than one particle in physical contact with one another, while an agglomerate comprises more than one aggregate in physical contact with one another. In one embodiment, the particles may agglomerate to form a structure with a fractal dimension of about 1 to about 3, i.e., it can be a mass fractal. In another embodiment, the particles may agglomerate to form a structure with a fractal dimension of about 3 to about 4, i.e., it can be a surface fractal. This can be measured using scattering techniques.

Any metals can be used in the nanoporous coating. Examples of metals are transition metals and platinum group metals from the periodic table. Examples of suitable metals are gold, platinum, silver, palladium, copper, aluminum, nickel, cobalt, titanium, tin, or the like, or a combination comprising at least one of the foregoing metals.

The ceramic can comprise inorganic oxides, metal oxides, silicates, borides, carbides, nitrides, perovskites and perovskites derivatives, or the like, or a combination comprising at least one of the foregoing. Examples of inorganic oxides include calcium oxide, silicon dioxide, or the like, or a combination comprising at least one of the foregoing inorganic oxides. In one embodiment, the ceramic comprises metal oxides of alkali metals, alkaline earth metals, transition metals, metalloids, poor metals, or the like, or a combination comprising at least one of the foregoing. In one embodiment, the ceramic can be in the form of an aerogel.

Examples of inorganic oxide and/or metal oxides are silicon dioxide, cerium oxide, magnesium oxide, titanium oxide, zinc oxide, copper oxide, cerium oxide, niobium oxide, tantalum oxide, yttrium oxide, zirconium oxide, aluminum oxide (e.g., alumina and/or fumed alumina), CaTiO₃, MgZrSrTiO₆, MgTiO₃, MgAl₂O₄, BaZrO₃, BaSnO₃, BaNb₂O₆, BaTa₂O₆, WO₃, MnO₂, SrZrO₃, SnTiO₄, ZrTiO₄, CaZrO₃, CaSnO₃, CaWO₄, MgTa₂O₆, MgZrO₃, La₂O₃, CaZrO₃, MgSnO₃, MgNb₂O₆, SrNb₂O₆, MgTa₂O₆, Ta₂O₃, or the like, or a combination comprising at least one of the foregoing metal oxides.

Examples of silicates are Na₂SiO₃, LiAlSiO₄, Li₄SiO₄, BaTiSi₃O₉, Al₂Si₂O₇, ZrSiO₄, KAlSi₃O₈, NaAlSi₃O₈, CaAl₂Si₂O₈, CaMgSi₂O₆, Zn₂SiO₄, or the like, or a combination comprising at least one of the foregoing silicates.

Examples of borides are lanthanum boride (LaB₆), cerium boride (CeB₆), strontium boride (SrB₆), aluminum boride, calcium boride (CaB₆), titanium boride (TiB₂), zirconium boride (ZrB₂), vanadium boride (VB₂), tantalum boride (TaB₂), chromium borides (CrB and CrB₂), molybdenum borides (MoB₂, Mo₂B₅ and MoB), tungsten boride (W₂B₅), or the like, or a combination comprising at least one of the foregoing borides.

Examples of carbides are silicon carbide, tungsten carbide, tantalum carbide, iron carbide, titanium carbide, or the like, or a combination comprising at least one of the foregoing carbides.

Examples of nitrides include silicon nitride, boron nitride, titanium nitride, aluminum nitride, molybdenum nitride, or the like, or a combination comprising at least one of the foregoing nitrides.

Examples of perovskites and perovskite derivatives include barium titanate (BaTiO₃), strontium titanate (SrTiO₃), barium strontium titanate, strontium-doped lanthanum manganate, lanthanum aluminum oxides (LaAlO₃), calcium copper titanate (CaCu₃Ti₄O₁₂), cadmium copper titanate (CdCu₃Ti₄O₁₂), Ca₁₋ₓLaₓMnO₃, (Li, Ti) doped NiO, lanthanum strontium copper oxides (LSCO), yttrium barium copper oxides (YBa₂Cu₃O₇), lead zirconate titanate, lanthanum-modified lead zirconate titanate, or the like, or a combination comprising at least one of the foregoing perovskites and perovskite derivatives.

As noted above, the ceramic may comprise nanoparticles. Commercially available examples of nanoparticles that can be used in the composition are calcium oxide commercially available as NANOACTIVE CALCIUM OXIDE™ or NANOACTIVE CALCIUM OXIDE PLUS™, cerium oxide commercially available as NANOACTIVE CERIUM OXIDE™, magnesium oxide commercially available as NANOACTIVE MAGNESIUM OXIDE™ or NANOACTIVE MAGNESIUM OXIDE PLUS™, titanium oxide commercially available as NANOACTIVE TITANIUM OXIDE™, zinc oxide commercially available as NANOACTIVE ZINC OXIDE™, silicon oxide commercially available as NANOACTIVE SILICON OXIDE™, copper oxide commercially available as NANOACTIVE COPPER OXIDE™, aluminum oxide commercially available as NANOACTIVE ALUMINUM OXIDE™ or NANOACTIVE ALUMINUM OXIDE PLUS™, all of which are commercially available from NanoScale Materials Incorporated. Another commercially available set of nanoparticles are aluminum oxide nanoparticles sold as NANODUR™ from Nanophase Technologies Corporation.

Polymers that can be used in the nanoporous coatings are generally aerogels or xerogels. Examples of polymeric aerogels or xerogels are resorcinol-formaldehyde aerogels or xerogels, phenol-formaldehyde aerogels or xerogels, or the like, or a combination comprising at least one of the foregoing polymeric aerogels.

The nanoporous coating can also comprise carbonaceous materials. Examples of nanoporous coatings that are carbonaceous are carbon black coatings, carbon nanotube coatings, carbon aerogel coatings, or the like, or a combination comprising at least one of the foregoing carbonaceous coatings. Carbon aerogels can be obtained by pyrolyzing the aforementioned polymeric aerogels.

In an exemplary embodiment, the nanoporous coating can comprise nanoparticles having any geometry. There is no particular limitation to the shape of the nanoparticles, which may be, for example, spherical, irregular, plate-like or whisker like.

The nanoparticles may generally have average largest dimensions of less than or equal to about 200 nanometers (nm). In one embodiment, the nanoparticles may have average largest dimensions of less than or equal to about 150 nm. In another embodiment, the nanoparticles may have average largest dimensions of less than or equal to about 100 nm. In yet another embodiment, the nanoparticles may have average largest dimensions of less than or equal to about 75 nm. In yet another embodiment, the nanoparticles may have average largest dimensions of less than or equal to about 50 nm. As stated above, the nanoparticles may generally have average largest dimensions of less than or equal to about 200 nm. In one embodiment, more than 90% of the nanoparticles have average largest dimensions less than or equal to about 200 nm. In another embodiment, more than 95% of the nanoparticles have average largest dimensions less than or equal to about 200 nm. In yet another embodiment, more than 99% of the nanoparticles have average largest dimensions less than or equal to about 200 nm. Bimodal or higher particle size distributions may be used.

The nanoporous coating can have a surface area of about 50 to about 1,200 square meters per gram (m²/gm). In one embodiment, nanoporous coating can have a surface area of about 100 to about 1,000 square meters per gram (m²/gm). In another embodiment, the nanoporous coating can have a surface area of about 150 to about 800 square meters per gram (m²/gm). In yet another embodiment, the nanoporous coating can have a surface area of about 200 to about 700 square meters per gram (m²/gm).

The nanoporous coating has pore sizes of about 5 to about 100 nanometers. In one embodiment, the nanoporous coating has pore sizes of about 10 to about 80 nanometers. In another embodiment, the nanoporous coating has pore sizes of about 15 to about 70 nanometers. In another embodiment, the nanoporous coating has pore sizes of about 20 to about 60 nanometers.

The nanoporous coating has a porosity of about 10 to about 99.9 volume percent, based on the total volume of the coating. In one embodiment, the nanoporous coating has a porosity of about 20 to about 90 volume percent, based on the total volume of the coating. In yet another embodiment, the nanoporous coating has a porosity of about 40 to about 70 volume percent, based on the total volume of the coating.

The nanoporous coating has a thickness of about 5 nanometers to about 10 micrometers. In one embodiment, the nanoporous coating has a thickness of about 5 nanometers to about 5 micrometers. In another embodiment, the nanoporous coating has a thickness of about 75 nanometers to about 2 micrometers. In an exemplary embodiment, the nanoporous coating has a thickness of about 100 nanometers to about 1 micrometer.

There are several different methods by which the nanoporous coating can be manufactured. In one embodiment, in one method of manufacturing the nanoporous coating, a slurry comprising the nanoparticles described above and a suitable liquid is disposed upon the substrate. The slurry can optionally contain a binder and an acid. The slurry may be disposed upon the substrate by spin coating, dip coating, brush painting, spray painting, electrostatic spray painting, or the like, or a combination comprising at least one of the foregoing methods.

The substrate with the slurry disposed thereon is then subjected to drying. The liquid from the slurry is evaporated during the drying, leaving behind the nanoporous coating to create a surface that delays the onset of the critical heat flux condition. In one embodiment, the drying can be conducted by subjecting the liquid in the slurry to heating causing it to evaporate. The heating can be brought about by conduction, convection and/or radiation. Radiation involving radio-waves, microwaves, or infrared waves can be used.

The nanoparticles are generally present in an amount of about 0.0001 volume percent (vol %) to about 1 vol %, based upon the total volume of the slurry. In another embodiment, the nanoparticles are present in an amount of about 0.001 vol % to about 0.1 vol %, based upon the total volume of the slurry.

The liquid can be present in the slurry in an amount of about 30 to about 99.9 vol %. In one embodiment, the liquid can be present in the slurry in an amount of about 60 to about 99 vol %. In another embodiment, the liquid can be present in the slurry in an amount of about 70 to about 98 vol %.

In another embodiment, pertaining to the manufacturing of the nanoporous coating, a slurry comprising nanoparticles is disposed upon the substrate. As noted above, the slurry comprises a first liquid and about 0.0001 to about 1 volume percent of nanoparticles, based upon the total volume of the slurry. The first liquid can be any suitable liquid in which the nanoparticles can be suspended, dispersed or solubilized. The first liquid is then evaporated to form a nanoporous coating having a thickness of about 5 nanometers to about 10 micrometers upon the substrate. Following the formation of the nanoporous coating, the surface is contacted with a second liquid that is generally heated. The second liquid can be the same or different from the liquid. The presence of the nanoporous coating causes the onset of the critical heat flux condition to be increased by an amount of about 20% to about 100% over a comparative surface that does not have the nanoporous coating.

In another embodiment, pertaining to the manufacturing of the nanoporous coating, a reactive solution comprising a substrate precursor such as an inorganic alkoxide is mixed in a vessel with a suitable solvent, a modifier, and an optional suitable surfactant. The reactive solution, which is initially in the form of a sol is converted to a gel by the sol gel process. The reactive solution in the form of a sol is then disposed on the substrate. In one embodiment, the gel disposed on the substrate is optionally washed, dried and calcined to yield a nanoporous composition that is disposed upon a porous substrate. In another embodiment, the solvent present in the gel disposed upon the substrate is exchanged with a supercritical fluid (e.g., supercritical carbon dioxide) to yield an aerogel. In yet another embodiment, the gel is treated with an agent such as trimethylchlorosilane, hexamethylenedisilazane, or the like, or combinations comprising at least one of trimethylchlorosilane or hexamethylenedisilazane to yield an aerogel.

Examples of suitable inorganic alkoxides are tetraethylorthosilicate, tetramethylorthosilicate, aluminum isopropoxide, aluminum tributoxide, aluminum ethoxide, aluminum-tri-sec-butoxide, aluminum tert-butoxide, antimony(III) ethoxide, antimony(III) isopropoxide, antimony(III) methoxide, antimony(III) propoxide, barium isopropoxide, calcium isopropoxide, calcium methoxide, chlorotriisopropoxytitanium, magnesium di-tert-butoxide, magnesium ethoxide, magnesium methoxide, strontium isopropoxide, tantalum(V) butoxide, tantalum(V) ethoxide, tantalum(V) ethoxide, tantalum(V) methoxide, tin(IV) tert-butoxide, diisopropoxytitanium bis(acetylacetonate) solution, titanium(IV) (triethanolaminato)isopropoxide solution, titanium(IV) 2-ethylhexyloxide, titanium(IV) bis(ethyl acetoacetato)diisopropoxide, titanium(IV) butoxide, titanium(IV) butoxide, titanium(IV) diisopropoxidebis(2,2,6,6-tetramethyl-3,5-heptanedionate), titanium(IV) ethoxide, titanium(IV) isopropoxide, titanium(IV) methoxide, titanium(IV) tert-butoxide, vanadium(V) oxytriethoxide, vanadium(V) oxytriisopropoxide, yttrium(III) butoxide, yttrium(III) isopropoxide, zirconium(IV) bis(diethyl citrato)dipropoxide, zirconium(IV) butoxide, zirconium(IV) diisopropoxidebis(2,2,6,6-tetramethyl-3,5-heptanedionate), zirconium(IV) ethoxide, zirconium(IV) isopropoxide zirconium(IV) tert-butoxide, zirconium(IV) tert-butoxide, or the like, or a combination comprising at least one of the foregoing inorganic alkoxides. An exemplary inorganic alkoxide is aluminum sec-butoxide.

The reactive solution generally contains an inorganic alkoxide in an amount of about 1 to about 50 wt %, based upon the weight of the reactive solution. In one embodiment, the reactive solution generally contains an inorganic alkoxide in an amount of about 5 to about 20 wt %, based upon the weight of the reactive solution.

Solvents that are used may be aprotic polar solvents, polar protic solvents, non-polar solvents Examples of aprotic polar solvents are propylene carbonate, ethylene carbonate, butyrolactone, acetonitrile, benzonitrile, nitromethane, nitrobenzene, sulfolane, dimethylformamide, N-methylpyrrolidone, or the like, or combinations comprising at least one of the foregoing aprotic polar solvents. Examples of polar protic solvents are water, methanol, acetonitrile, nitromethane, ethanol, propanol, isopropanol, butanol, or the like, or combinations comprising at least one of the foregoing polar protic solvents. Examples of non polar solvents include benzene, toluene, methylene chloride, carbon tetrachloride, hexane, diethyl ether, tetrahydrofuran, or the like, or combinations comprising at least one of the foregoing non polar solvents. Co-solvents may also be used. Ionic liquids may also be utilized as solvents during the gelation. An exemplary solvent is ethanol.

Solvents are generally added in an amount of about 0.5 wt % to about 300 wt %, specifically about 1 to about 200 wt %, more specifically about 70 to about 100 wt %, based on the total weight of the reactive solution.

The modifiers may control the hydrolysis kinetics of the inorganic alkoxides. Examples of suitable modifiers are ethyl acetoacetate, ethylene glycol, or the like, or a combination comprising at least one of the foregoing modifiers. The reactive solution generally contains the modifier in an amount of about 0.1 to about 5 wt %, based upon the weight of the reactive solution.

The surfactants are optional and can be anionic surfactants, cationic surfactants, non-ionic surfactants, zwitterionic surfactants, or a combination comprising at least one of the foregoing surfactants. The surfactants serve as templates and facilitate the production of substrates containing directionally aligned tubular mesochannels forms. The reactive solution generally contains the surfactant in an amount of about 0.1 to about 5 wt %, based upon the weight of the reactive solution. An exemplary surfactant is octylphenol ethoxylate commercially available as TRITON X 114®.

An acid catalyst or a basic catalyst may be used to promote gelation of the metal alkoxide. Acid catalysts (having a pH of about 1 to about 6) generally promote ramified porous structures, while basic catalysts (having a pH of about 8 to about 14) promote compact porous structures. Acid catalysts generally promote the formation of mass fractals having fractal dimensions from about 1 to about 3, while basic catalysts generally promote the formation of surface fractals having fractal dimensions of about 3 to about 4.

In yet another embodiment, the substrate can comprise a transition metal be coated with a layer of a transition metal. The substrate can be placed in a furnace in a carbonaceous environment to grow a layer of carbon nanotubes on the surface. The layer of carbon nanotubes serves acts as a nanoporous coating. A layer comprising nanorods, whiskers, nanowires, and the like, can be grown (in lieu of the carbon nanotubes or in combination with the carbon nanotubes) on the substrate to form the nanoporous coating.

As noted above, the nanoporous coating provides the substrate with an ability to delay the onset of the critical heat flux condition by an amount of up about 30% to about 120%, when the surface is exposed to a given fluid. In one embodiment, the nanoporous coating provides the substrate with an ability to delay the onset of the critical heat flux condition by an amount of up about 50% to about 110%, when the surface is exposed to a given fluid. In another embodiment, the nanoporous coating provides the substrate with an ability to delay the onset of the critical heat flux condition by an amount of up about 60% to about 100%, when the surface is exposed to a given fluid. In one embodiment, the nanoporous coating provides the substrate with an ability to delay the onset of the critical heat flux condition by an amount of up about 70% to about 90%, when the surface is exposed to a given fluid.

In an exemplary embodiment, the substrate with the nanoporous coating disposed thereon is part of an article where a surface of the substrate in contact with the nanoporous coating is employed in the vertical position. As noted above, vertical surfaces are most at risk for an early onset of critical heat flux condition resulting in damage to the surface. Gravity plays a limited role in mitigating the onset of the critical heat flux condition in vertical surfaces. The ability of a surface that is not in the horizontal position to delay the onset of the critical heat flux condition provides a significant advantage to articles employing these non-horizontal surfaces. Articles where the nanoporous coating can be employed are nuclear reactors where they can be used as a nuclear fuel rod. They can also be used in power electronic modules used for avionics, magnetic resonance imaging gradient drivers, and the like.

The following examples, which are meant to be exemplary, not limiting, illustrate compositions and methods of manufacturing of some of the nanoporous coatings described herein.

### Examples

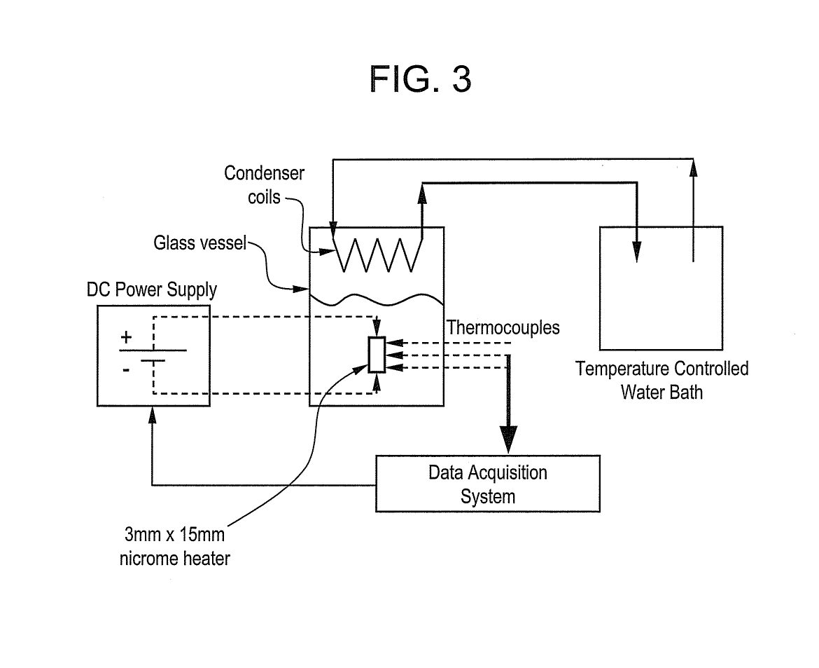

These examples were conducted to demonstrate the ability of the nanoporous coating to delay the onset of the critical heat flux condition. The experimental setup, as depicted in FIG. 3, consists of a glass vessel, a nichrome resistive heater, a TEFLON® insulating substrate (not shown), a water bath, condenser coils, power supply, thermocouples, a hot plate, a KAPTON® heater, and a data acquisition system.

Two examples were conducted—a comparative example and an example that demonstrates the nanoporous coating of the disclosure. In the comparative example, nanoparticles were dispersed in water and the critical heat flux was measured on a polished surface of the nichrome heater that was disposed in the water. In the example demonstrating the nanoporous coating, an alumina nanoporous coating was disposed on the surface of the nichrome heater and the critical heat flux was measured in water, with the exception that this time around, the water did not contain the nanoparticles.

With reference to the FIG. 3, the glass vessel has disposed in it the nichrome resistive heater, the thermocouples, and the condenser coils. The insulating plate is located inside the glass vessel that houses the nichrome heater. It is made out of TEFLON®. It has a cavity at its center where the nichrome heater is mounted. The nichrome resistive heater is used to heat the fluid that is present in the glass vessel. As will be detailed later, the nichrome heater is used to measure the onset of the critical heat flux either in its bare state (i.e., without a coating disposed thereon) or with a nanoporous coating disposed thereon. The nichrome heater therefore behaves as the substrate. The nanoporous coating comprises either alumina particles or gold particles. The water present in the glass vessel was either pure water or water having nanoparticles disposed therein.

When the nichrome heater did not have a nanoporous coating, the water present in the glass vessel had nanoparticles disposed in it, while when the nichrome heater had a nanoporous coating disposed thereon, the water was pure (i.e., it did not contain any nanoparticles and is referred to as deionized water.

The KAPTON® heater is wound around the glass vessel to heat the water present in the vessel. The KAPTON® heater is also present at the base of the vessel to uniformly heat the water present in the vessel.

Condensation water is circulated with a pump through condenser coils, which are positioned at the top of the glass vessel to minimize fluid loss. Water that is heated in the vessel evaporates and is condensed by the condenser coils. The condensation of water facilitates maintaining a nearly constant concentration of the nanoparticles in the water. The condensation coils are connected to the water bath. De-ionized water is used as the base fluid in the water bath and its bulk temperature kept constant at saturation temperature throughout the experiments using a hot plate on the bottom (not shown). The opening of the glass vessel is protected with a foil (e.g., aluminum) that has a few holes in it. The use of a foil with holes in it prevents a build up of pressure within the glass vessel.

The nichrome foil is 15 millimeters long, 3 millimeters wide and 38 micrometers thick. The nichrome foil is used as a resistive heater, and energized with a 120 V, 18 A DC power supply as shown in the FIG. 3. Power supply output is controlled by the data acquisition system and power to the heater is gradually increased while three thermocouples, installed on the back of the heater, are monitoring the surface temperatures. Heat flux is increased in 2 watt per square centimeter (W/cm²) increments up to 70 W/cm² and 0.5 W/cm² increments till the critical heat flux is reached. At each heat flux setting, steady state is arrived at. Steady state is assumed when surface temperature variations are less than 0.4° C. for 2 minutes. At each steady state, data is recorded, following which the power is moved to the next power setting. The critical heat flux condition is assumed to occur when differences between the two successive temperature readings are more than 5° C. The experimental uncertainty for heat flux measurements is calculated as ±5.1% at 100 W/cm² and ±3.2% at 200 W/cm².

As noted above, alumina and gold particles were used for testing and two different experimental approaches are used to determine effect of the fluid properties and surface characteristics on the critical heat flux condition.

### Comparative Example 1

First, alumina particles having an average particle size of 100 nanometers were mixed with dielectric water at concentrations varying from 0.0001 vol % to 1 vol % (based on the total volume of the water and the alumina particles) and tests to determine the onset of the critical heat flux condition were run on a nichrome heater having a clean polished surface.

Alumina nanoparticle suspensions with concentrations ranging from 0.0001 to 0.1 vol % (the volume percents being based on the volume of the alumina nanoparticles and the water) were prepared by diluting a concentrated suspension with acidified water. The acid content helps to improve the degree of dispersion and the overall stability of the suspension. For the alumina nanoparticles, complete dispersion occurred when the pH was lowered to 4. A 33 wt % concentrate was prepared by combining 49.5 grams (g) water, 0.5 g of nitric acid having a pH of 2, 25 g of nanoparticle alumina (Al₂O₃) nanopowder, and 150 g YTP milling media (5 mm) in a small plastic bottle, followed by ball-milling for 48 hours. The suspension was diluted with water having a pH of 4 to produce a suspension with the desired concentration. Nanoparticle suspensions produced using this approach were stable for several months.

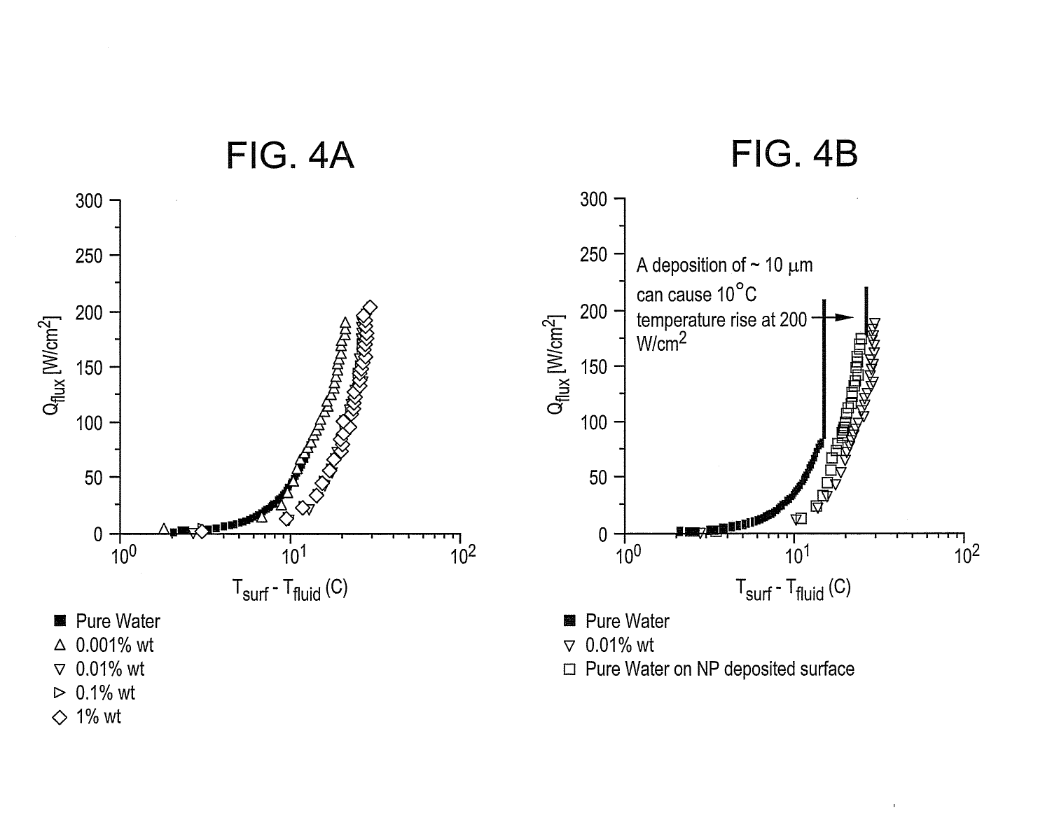

The tests were conducted as described above. The results are shown in the FIG. 4(a). The FIG. 4(a) is a graphical plot of heat flux in watts per square centimeter measured as a function of the difference in temperature (in degrees centigrade) between the nichrome heater surface temperature and the fluid temperature. As can be seen in the FIG. 4(a), the critical heat flux increases with the increase in alumina content. In addition, it can be seen that with the increasing heat flux (as a result of increasing alumina concentration), there is also an increase in the difference in temperature between the nichrome heater surface temperature and the surrounding fluid temperature.

### Example 1

In this example, the same alumina as that used in the Comparative Example 1 was disposed in the form of a porous coating upon the nichrome heater. The thickness of the nanoporous coating was approximately 1 micrometer. This new nanoporous coating surface is then used as the boiling surface (in lieu of the polished surface of the nichrome heater of the Comparative Example 1) so that nothing but surface effects exist.

The nanoporous coating is formed prior to experiments by injecting droplets of nanofluid solutions onto the surface then letting the water content evaporate causing nanoparticles to be left on the surface forming a nanostructured coating. Surfaces prepared using this method are tested 3 times, each with a clean pool of water in the glass vessel, to evaluate the durability of the coating.

The results are shown in the FIG. 4(b). The FIG. 4(b) (like the FIG. 4(a)) is a graphical plot of heat flux in watts per square centimeter measured as a function of the difference in temperature (in degrees centigrade) between the nanoporous coating surface temperature and the surrounding fluid temperature. The FIG. 4(b) shows the critical heat flux for pure water on a polished nichrome surface, pure water on the nanoporous surface and for water containing alumina nanoparticles on a polished nichrome heating surface. As can be seen in the FIG. 4(b), the critical heat flux is increased when the alumina particles are disposed upon the surface in the form of a nanoporous coating as opposed to when they are contained in the fluid. This demonstrates that the nanoporous coating is superior in delaying the onset of the critical heat flux condition especially when compared with disposing the nanoparticles in the solution.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention.

1. An article comprising:
a substrate; and
a nanoporous coating disposed thereon; the nanoporous coating having a thickness of about 5 nanometers to about 10 micrometers; where an interface between the substrate and the nanoporous coating is disposed at an angle of about 60 degrees to about 120 degrees to a horizontal; the nanoporous coating being in contact with a liquid; the nanoporous coating being operative to improve the critical heat flux by an amount of about 20% to about 100% over a surface that does not have a nanoporous coating.

2. The article of claim 1, where the interface between the substrate and the nanoporous coating is disposed at an angle of about 75 degrees to about 105 degrees to the horizontal.

3. The article of claim 1, where the interface between the substrate and the nanoporous coating is disposed at an angle of about 85 degrees to about 95 degrees to the horizontal.

4. The article of claim 1, where the nanoporous coating comprises a metal, a polymer, a ceramic or a combination comprising at least one of the foregoing metals, polymers or ceramics.

5. The article of claim 4, where the metal is gold, platinum, silver, palladium, copper, aluminum, nickel, cobalt, titanium, tin, or a combination comprising at least one of the foregoing metals.

6. The article of claim 4, where the ceramic is an inorganic oxide, a metal oxide, a silicate, a boride, a carbide, a nitride, a perovskite, a perovskite derivative, or a combination comprising at least one of the foregoing ceramics.

7. The article of claim 6, where the inorganic oxide and/or metal oxide is silicon dioxide, cerium oxide, magnesium oxide, titanium oxide, zinc oxide, copper oxide, cerium oxide, niobium oxide, tantalum oxide, yttrium oxide, zirconium oxide, aluminum oxide, CaTiO₃, MgZrSrTiO₆, MgTiO₃, MgAl₂O₄, BaZrO₃, BaSnO₃, BaNb₂O₆, BaTa₂O₆, WO₃, MnO₂, SrZrO₃, SnTiO₄, ZrTiO₄, CaZrO₃, CaSnO₃, CaWO₄, MgTa₂O₆, MgZrO₃, La₂O₃, CaZrO₃, MgSnO₃, MgNb₂O₆, SrNb₂O₆, MgTa₂O₆, Ta₂O₃, or a combination comprising at least one of the foregoing metal oxides.

8. The article of claim 6, where the silicate is Na₂SiO₃, LiAlSiO₄, Li₄SiO₄, BaTiSi₃O₉, Al₂Si₂O₇, ZrSiO₄, KAlSi₃O₈, NaAlSi₃O₈, CaAl₂Si₂O₈, CaMgSi₂O₆, Zn₂SiO₄, or a combination comprising at least one of the foregoing silicates.

9. The article of claim 6, where the borides are lanthanum boride, cerium boride, strontium boride, aluminum boride, calcium boride, titanium boride, zirconium boride, vanadium boride, tantalum boride, chromium borides, molybdenum borides, tungsten boride, or a combination comprising at least one of the foregoing borides.

10. The article of claim 6, where the carbides are silicon carbide, tungsten carbide, tantalum carbide, iron carbide, titanium carbide, or a combination comprising at least one of the foregoing carbides.

11. The article of claim 6, where the perovskites and perovskite derivatives are barium titanate, strontium titanate, barium strontium titanate, strontium-doped lanthanum manganate, lanthanum aluminum oxides, calcium copper titanate, cadmium copper titanate, Ca₁₋ₓLaₓMnO₃, (Li, Ti) doped NiO, lanthanum strontium copper oxides, yttrium barium copper oxides, lead zirconate titanate, lanthanum-modified lead zirconate titanate, or a combination comprising at least one of the foregoing perovskites and perovskite derivatives.

12. The article of claim 1, where the nanoporous coating comprises an aerogel or a xerogel.

13. The article of claim 1, where the nanoporous coating comprises carbon.

14. The article of claim 1, where the nanoporous coating comprises particles having an average particle size of less than or equal to about 200 nanometers.

15. The article of claim 1, where the nanoporous coating has pore sizes of about 5 to about 100 nanometers.

16. The article of claim 1, where the nanoporous coating has a porosity of about 10 to about 90 volume percent, based on the total volume of the coating.

17. The article of claim 1, where the nanoporous coating has a thickness of about 100 nanometers to about 1 micrometer.

18. The article of claim 1, where the article is a pipe, a power electronic module, a magnetic resonance imaging gradient driver or a nuclear fuel rod.

19. An article comprising:
a substrate; and
a nanoporous coating disposed thereon; the nanoporous coating comprising a metal or a metal oxide; the nanoporous coating having a thickness of about 5 nanometers to about 10 micrometers; where an interface between the substrate and the nanoporous coating is disposed at an angle of about 60 degrees to about 120 degrees to a horizontal.

20. The article of claim 19, where the metal is gold, platinum, silver, palladium, copper, aluminum, nickel, cobalt, titanium, tin, or a combination comprising at least one of the foregoing metals.

21. The article of claim 19, where the metal oxide is zirconium dioxide, titanium dioxide, aluminum oxide, tin oxide, niobium oxide, silicon dioxide, or a combination comprising at least one of the foregoing metal oxides.

22. A method comprising:
disposing a slurry upon a substrate; the slurry comprising a liquid and about 0.0001 to about 1 volume percent of nanoparticles, based upon the total volume of the slurry; and
evaporating the liquid from the substrate to form a nanoporous coating having a thickness of about 5 nanometers to about 10 micrometers upon the substrate.

23. The method of claim 22, where the evaporating is brought about by heating the liquid.

24. The method of claim 22, where the disposing of the slurry upon the substrate is accomplished by spin coating, dip coating, spray painting, electrostatic spray painting or dip coating.

25. An article manufactured by the method of claim 22.

26. The article of claim 22, where the article is a pipe, a power electronic module, a magnetic resonance imaging gradient driver or a nuclear fuel rod.

27. A method comprising:
disposing a slurry upon a substrate; the slurry comprising a first liquid and about 0.0001 to about 1 volume percent of nanoparticles, based upon the total volume of the slurry;
evaporating the first liquid to form a nanoporous coating having a thickness of about 5 nanometers to about 10 micrometers upon the substrate; and
contacting the nanoporous coating with a second liquid; where the onset of the critical heat flux condition is increased by an amount of about 20% to about 100% over a surface that does not have the nanoporous coating.

28. The method of claim 27, further comprising heating the slurry.

29. The method of claim 27, further comprising heating the second liquid.
